(19) United States
(12) Patent Application Publication
(10) Pub. No.: US 2010/0030565 A1
(43) Pub. Date: Feb. 4, 2010

(54) GROUP BASED TASK ANALYSIS

(76) Inventors: Alexander W. Holt, New Paltz, NY (US); Michael E. Moran, Ridgewood, NJ (US); Jeffrey S. Schaffer, Ridgefield, CT (US)

Correspondence Address: HOFFMAN WARNICK LLC, 75 STATE ST, 14 FL, ALBANY, NY, 12207, US

(21) Appl. No.: 12/184,365

(22) Filed: Aug. 1, 2008

(51) Int. Cl. G06Q 30/00; G06F 15/00

(52) U.S. Cl. 705/1; 702/127

(57) ABSTRACT

A system, method and program product for analyzing tasks being performed by a group in an online environment. Included is a task definition system for associating subsets of documents available via a content delivery system with a plurality of tasks; a group identification system for identifying a group to which a user participating in the e-commerce environment belongs; a tracking system for tracking which documents have been viewed by users within the group; a task determination system for determining which of the plurality of tasks the group is engaged in performing; and a progress analysis system for analyzing a progress the group has achieved towards completing the task.

### FIELD OF THE INVENTION

This disclosure relates to analyzing tasks performed by a group of users, and more particularly relates to a system and method of identifying a group that a user belongs to, determining a task being performed by the group of users, assessing progress of the task, and determining a response.

### BACKGROUND OF THE INVENTION

Unlike businesses with face to face sales people, interactive businesses have difficulty knowing when a group of users are working together to complete some task, which prevents the business from providing the most effective service to the group. For instance, in making a large scale purchasing effort of information technology equipment, different users within the group may need to visit a website to thoroughly investigate different features such as specifications, compatibility, availability, costs, etc. In such an environment, there may be no typical path that the group of users follows. Instead, users from the group may randomly select different content at different times until enough information is gathered to make a purchasing decision. Furthermore, in many cases, users from the group may need multiple visits over time to accomplish their task. Given this approach, effectively improving the group user experience and marketing effort is a challenge, since present day websites lack an understanding of how far the users in the group have progressed in completing the group based task.

Current measurements of web and other interactive marketing activity do not correlate to tasks and further fail to treat group activity as a single task. This lack of information hamstrings a marketer from accurately assessing deals in the pipeline, and diminishes the ability to respond to the group with the information needed to persuade the company to make the purchase. This is a common problem in business to business (B2B) marketing, but any group activity (marketing or otherwise) faces similar problems.

Under the current state of the art, marketers cannot identify the common task that individuals are performing, cannot assess progress towards completion of that task by the group, cannot project business results (such as revenue and profit), and cannot provide the best marketing information needed by the group, i.e., the information that might make or break a deal in progress.

B2B marketers have traditionally used dedicated sales forces to close business, but more and more, that business has moved to the Web, particularly for the early stages of the buying process. Some B2B businesses use Web sites for e-commerce, but most support customer tasks such as researching and configuring products and services, allowing the actual purchase to be made through an offline channel. With a sales force, B2B marketers can usually assess the state of any particular deal, can project the likelihood of closing that deal, and can count on the sales force to present the best possible information to the customer to get that deal closed. In online marketing, the process is much more challenging.

Accordingly, a need exists for a more robust process for analyzing tasks being performed by a related group of users in an online environment.

### SUMMARY OF THE INVENTION

The present disclosure relates to a system, method and program product for determining a task being performed by a related group of users at a online environment, such as a Web site, e-commerce or other network based system, determining how complete the task is, and for determining an effective marketing response to the group of users based on task completeness.

In one embodiment, there is a system for analyzing tasks being performed by a group in an online environment, comprising: a task definition system for associating subsets of documents available via a content delivery system with a plurality of tasks; a group identification system for identifying a group to which a user participating in the online environment belongs; a tracking system for tracking which documents have been viewed by users within the group; a task determination system for determining which of the plurality of tasks the group is engaged in performing; and a progress analysis system for analyzing the progress the group has achieved towards completing the task.

In a second embodiment, there is a method of analyzing tasks being performed by a group in an online environment, comprising: associating subsets of documents available via a content delivery system with a plurality of tasks; identifying a group to which a user participating in the online environment belongs; tracking which documents have been viewed by users within the group; determining which of the plurality of tasks the group is engaged in performing; and analyzing the progress the group has achieved towards completing the task.

In a third embodiment, there is a computer readable medium having a computer program product stored thereon for analyzing a task in an online environment, comprising: program code for associating subsets of documents available via a content delivery system with a plurality of tasks; program code for identifying a group to which a user participating in the online environment belongs; program code for tracking which documents have been viewed by users within the group; program code for determining which of the plurality of tasks the group is engaged in performing; and program code for analyzing a progress the group has achieved towards completing the task.

In a fourth embodiment, there is a method for deploying a system for measuring completeness of a task, comprising: providing a computer infrastructure being operable to: associate subsets of documents available via a content delivery system with a plurality of tasks; identify a group to which a user participating in the online environment belongs; track which documents have been viewed by users within the group; determine which of the plurality of tasks the group is engaged in performing; and analyze a progress the group has achieved towards completing the task.

Related case, U.S. Ser. No. 10/109,403, entitled Web Based Task Completeness Measurement, which is incorporated by reference, describes how a set of information, called “documents” can be identified as pertinent to a particular task, and how to track the number of documents that an individual has been exposed to. This disclosure furthers the art by allowing the marketer to: measure the number of documents shown to a group that are pertinent to a group task; discover patterns that groups employ when moving through the documents in the set; and persuade the group to complete the task by presenting the next most persuasive document to the group.

When implemented with a suitable conversion metric, it is possible to identify multiple potential conversions, or outcomes, for each task, and discover which pattern of documents viewed by the group lead to each outcome. Finally, by aggregating across all groups who have entered a task, it is possible to create a “pipeline” metric of the number of documents viewed per group and the number of groups currently at each point of the pipeline on the way to task completion.

Additionally, this information can be used by the marketer to dynamically adapt the customer experience to be more persuasive toward task completion. E-mails, banner ads, Web sites, and other marketing materials can be personalized to induce further progress toward task completion.

In addition, the described solution can thus use information about the customer's activity to suggest the best pages or documents to view at a website. An analysis that shows which pages are most important to a successful purchase can be used to suggest which pages a customer still needs to view to complete a task (defined, e.g., as viewing a set of core documents). A dynamic website is thus provided that can deliver a higher number of sales from the same number of total customers.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer system having a task analysis system in accordance with an embodiment of the present invention.

FIG. 2 depicts a set of characterized documents in accordance with an embodiment of the present invention.

FIG. 3 depicts a set of characterized documents along with an activity history in accordance with an embodiment of the present invention.

FIG. 4 depicts an overview of subgroups in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

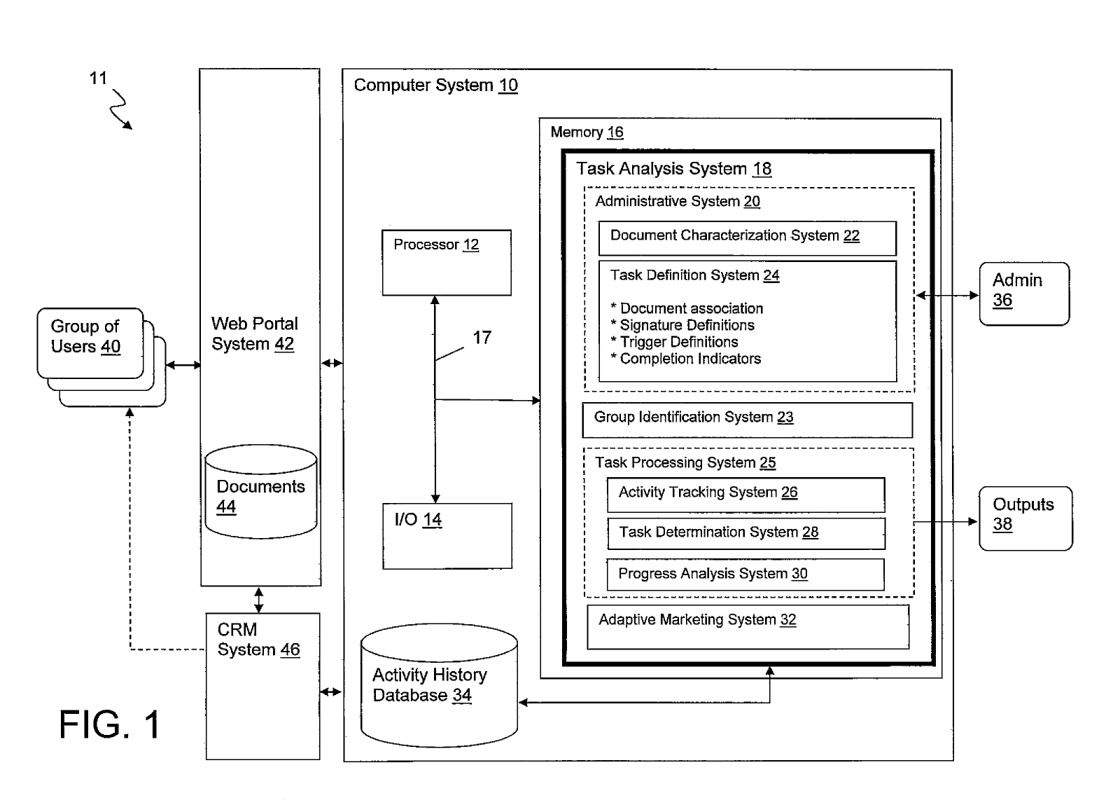

FIG. 1 depicts a group based marketing system 11 having a computer system 10 that includes a task analysis system 18. As described below, task analysis system 18 tracks how complete a task is being performed via a web portal system 42 by a group of users 40, and provides adaptive marketing back to the group of users 40. It is understood that task analysis system 18 could be partially or completely integrated into the web portal system 42. In addition, it is understood that web portal system 42 may comprise any online electronic content delivery system in which there is a desire to track a group's progress at completing a task. In an illustrative embodiment, web portal system 42 may comprise a B2B website that provides web pages and other content items that users 40 typically view prior to engaging in a purchase.

In this illustrative embodiment, completeness measurement system 18 tracks which documents 44 the group of users 40 has viewed or otherwise interacted with at web portal system 42 in completing a predefined task. For example, a group of users 40 from a company may be responsible for procuring an IT infrastructure from a vendor. Within the group, different users have different roles, e.g., a technical user from the group may be more interested in technical capabilities, while a business user may be more interested in costs. Based on some criteria (usage history, assumptions, etc.), task analysis system 18 may determine that a typical group of users 40 will view N different documents 44 at the vendor's website before making a purchasing decision. A document 44 may comprise any type of content item available via the web portal system 42 or related CRM system 46, e.g., a web page, a link, an advertisement, a technical document, a media stream, an email, a mailing, etc. Based on how complete the task is for the user 40, task analysis system 18 can implement dynamic marketing strategies via adaptive marketing system 32 to enhance the marketing effort/experience for the group of users 40. Outputs 38 may for instance include reports, analysis, feedback, etc.

As an example, consider the case of a company seeking to purchase a computer server via the Internet. Employees at the company might decide to identify and research potential purchase candidates when prompted by a banner ad, an e-mail, some offline marketing stimulus or completely of their own volition. In the course of such research, various employees may view a number of documents about the server to obtain the needed information. Task analysis system 18 allows a marketer to understand what documents the company has been exposed to (i.e., document impressions) and which ones caused the company to make forward progress in the purchasing task.

As complex as it is to track such document impressions for business to customer (B2C) purchases and other individual tasks, tracking business to business B2B tasks is even more challenging. The group may split up the investigative work, with some members examining product features (such as which size blade servers fit into the racks the company owns) and others examining business aspects of the purchase (such as which forms of payment are required and whether the shipping costs will fit into the hardware budget).

The present disclosure addresses some of these challenges by providing a mechanism to identify groups to which users may belong. This allows the marketer to correlate the users to the larger groups they belong to. Also provided is a mechanism for tracking activity across the group. Once the marketer knows which individuals belong to which groups, this allows the marketer to track individual activities as progress toward the larger group goal. Finally, by analyzing the progress a group is making, adapting marketing to the group can be employed. Marketers can use the information received from activity tracking to determine the best “next” document to show the group to persuade them to complete the task.

Illustrative methods to identify individuals as part of a group for tracking group tasks may include:
E-mail addresses. Most companies provide e-mail addresses to employees that share a common domain, allowing tracking of activity by individuals to be grouped under that company's group.
Registrations. If customers log into a Web site, marketers can request that they disclose their company affiliations when they register. In some cases, users could log in indicating that they are part of a defined group.
IP identifications. Techniques exist to look up a visitor's IP address, matching it against an identity table of companies to determine which IP addresses correspond to a single company.

Note that the above is not a comprehensive list, and any technique for identifying individuals as part of a group could be utilized.

The present disclosure also determines the task being performed by the group by identifying the documents that are part of that task. The more of the documents the group views (e.g., across multiple sessions), the more likely it is that they are performing a particular task. By aggregating the activity of those identified as being part of a group (as explained above), the group can be detected as engaging in a task. Instead of recognizing only that an individual has viewed multiple documents pertaining to a task, task analysis system 18 can also notice that multiple users within an identified group have viewed such items. Essentially, the group-based marketing system 11 can treat all members of an identified group the same way it would treat an individual in a B2C marketing situation.

Once a group of users 40 are identified as working together on a task, their progress is tracked as a group. An administrator (e.g., marketer) can define the tasks, along with the documents historically shown to be most persuasive in inducing a customer to convert. Marketers can assess the group's progress based on the number of those documents seen by the members of the group and can adapt the customer experience to present the documents that have not been seen.

Using the computer server purchase example, the marketer can observe how many members of the group have seen the documents identified as part of that task. By counting document impressions across the group, the marketer can assess the interest of the group in the subject and can project the likelihood that the group will complete the task (e.g., purchasing a server) based on the historical propensity of groups viewing a similar number of document impressions in the past having purchased.

While identifying that a group is performing a task and tracking the group's progress can be handled through simply aggregating the collective activity of the individuals in the group, the response to that information may need to be more nuanced. For individuals, it is sufficient to use historical data of which documents have produced the most conversions to decide the order in which unseen content should be shown. A very simple implementation of this system for groups could treat each individual member of the group separately, merely trying to expose each member of the group to every last content item from the set of persuasive documents that that individual has not already viewed.

In a more robust embodiment, group-based marketing system 11 can systematically expose the group to the overall set of documents that make up the task. In this implementation, group-based marking system 11 ensures that the collective group sees all the necessary documents. In this case, the system 11 can expose any member of the group to the most persuasive document unseen by anyone in the group. Because the group is assumed to be working together, their collective knowledge will be shared among the group and persuasion will occur faster.

As time goes on, historical data can be collected on groups, task by task, allowing the system 11 an even more sophisticated approach, where task completion is accelerated by, e.g., exposing many or all of the members of the group to certain core documents, while exposing certain individuals in the group to secondary documents. Which documents are core rather than secondary for a particular task may be determined by analyzing conversion histories of which documents groups have seen before converting.

Returning again to the computer server purchase example, analyzing historical conversion data might reveal that five documents consist of the core information for that task: a business overview of the server model, a technical specifications page, a white paper on the server's technology, and any two case studies mentioning that server. These documents may for instance be identified as core information because they are highly correlated with server purchases.

Once known, the analysis may delve deeper, looking at the relationship between server purchases and all of the information that groups look at before a purchase. It might be that once a group collectively has seen 70% of the documents in the task, and once 60% of the group has seen three or more of the core documents, the group has a 65% chance of purchasing the server.

This information is then used by the adaptive marketing system 32 and CRM system 46 to build the business rules that decide what content to show similar groups identified in that same or similar task. Group-based marketing system 11 assesses how many members of the group have viewed each content item and then systematically exposes them to links on the pages they select, enticing them to view the most persuasive items left. The system 11 may expose a member of the group to a new item unseen by anyone in the group. In this case, the system 11 would also want to expose the same core content information to multiple members of the group, because that is highly correlated to group purchase of a server.

A further embodiment includes looking for sub-patterns within a group. For example, analysis might show that typically one of the members of a group views one subset of the documents while another member views a largely different set. When a member of a new group is visiting a site, her individual pattern may closely resemble that of one of the typical historical sub-patterns. In this case, the system would prefer to expose documents from the matched sub-pattern that the current visitor had not already viewed. In this way, users within groups would automatically define their own sub-patterns, new visitors would automatically segment themselves within one of the historical sub-patterns, and the system would implicitly personalize each visitor's experience accordingly.

Task analysis system 18 may also track information about the group or about its individual members, thus allowing the business rules to expose documents more explicitly. For example, if the marketer knows which operating system the customer has standardized in its company, the server documents exposed can be limited to those that meet those standards. In this way, anything that can constrain the choices of which documents are most likely to persuade a particular company can be applied to limit the number of possibilities to those most likely to lead to conversion.

Likewise, information about each member of the group can be used to personalize the experience. In the case of the server purchase, knowing which members of the group have different job roles within the company can be vital to selecting the very most persuasive documents. Using the server example, the business rules could be tuned so that the technical specifications and white paper documents were shown to people in the IT group, while the business overview might be more likely to be shown to the purchasing agent. The historical analysis of the patterns of which documents led to purchase can be expanded to identify which roles saw which information—this can speed up purchasing by exposing the right information to the right person within the group.

This example implements personalization based on role, but different marketers might have different information that allows their business rules to be sharpened to be more persuasive. Any type of strategic information may be used to refine the marketing effort, e.g., demographics, firmographics, historical activity, stated interests, etc. Whatever information the marketer has about the group and the members of the group can be used, especially if the historical analysis shows a correlation to higher conversion based on that information. Marketers can implement this approach as a high-tech version of messaging based on market segmentation.

While the examples shown here have focused on the example of purchasing and product research, this invention can be applied to any task that can be identified. Examples include customer service, support tasks, tasks for contacting a company offline, gaming, etc.

In addition, while the examples shown here employ a personalized web site to present the “next” document, any method to present a document can be employed. E-mail re-contact strategies, personalized RSS feeds, outbound calls, and other methods can be used to present the “next” piece of information to the customer, i.e., the information most likely to persuade completion of the task.

Task analysis system 18 generally includes an administrative system 20 for configuring or allowing an administrator 36 (e.g., vendor, marketer, etc.) to configure the operational parameters of task analysis system 18; a group identification system 23 for determining if a user is a member of a group; a task processing system 25 for analyzing user activities whenever members of a group engage with web portal system 42; and an adaptive marketing system 32 for providing dynamic marketing services to the group of users 40.

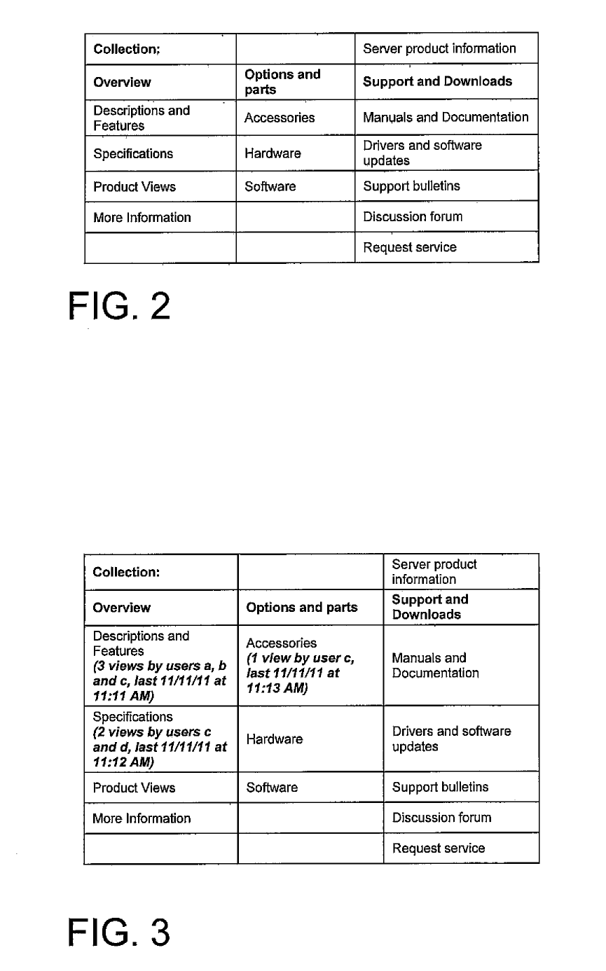

Administrative system 20 generally includes a document characterization system 22 and a task definition system 24. Document characterization system 22 creates an organization of the available documents 44 for a subject that facilitates understanding and analysis. For example, for documents 44 that relate to a server product, the organization shown in FIG. 2 might be created. In this example, the types of documents available on web portal system 42 relating to server products are arranged in a table. In this case, web portal system 42 includes documents that provide Overviews, Options and Parts, and Support and Downloads. Each of these is further refined, e.g., overview documents include Descriptions and Features, Specifications, Products Views and More Information.

Note that a website may contain many documents or pages about a range of subjects. The tasks that users come to the website to perform may involve multiple subjects or just one. The present invention can be applied in either case, but for the sake of simplifying this discussion, tasks that involve single subjects are described. Note also that a collection of documents about a single subject frequently supports more than one task (e.g., purchasing as well as technical support).

Task definition system 24 defines tasks a group of users 40 might perform while visiting web portal system 42, and may be implemented using any approach. A task may include any goal or set of actions being performed by the group of users 40 in conjunction with the web portal system 42. Illustrative tasks may include, e.g., purchasing, support, entertainment, education, etc. Tasks can also be defined at any breadth, e.g., “purchasing a server” versus “purchasing a midrange server for less than $20,000 to handle 20-50 users in a small business.” In one embodiment, the administrator 36 (e.g., marketer) can define tasks the web portal system 42 is intended to support. In another embodiment, users can be polled (or other user testing can be performed) to identify the tasks they perform when they visit the site. Other techniques can be employed as well. In a further embodiment, task definitions can be validated by users through a feedback mechanism to ensure that the tasks to be supported by the web portal system 42 correspond well with user expectations.

Once a task is defined, a set of documents are associated with the task. The associated set of documents represents a subset of the documents 44 available through the web portal system 42 that are typically viewed before a group of users 40 has completed the task. Each such set of documents is preferably tailored to represent the most common pattern of visitor activity within the subject for users who successfully conclude the task. The set of documents may contain sequence information, i.e., which documents are typically viewed before others by task completers, but in other cases need not be viewed in any particular order. In addition, documents within the set that distinguishes groups of users 40 who successfully conclude the task from users who do not are considered persuasive and may be referred to as “core” documents. The document sets can be determined in any manner.

In one embodiment, the administrator 36 (e.g., marketer) can identify the exact set of documents required to complete a task, e.g., complete a form, read warranty, and download a trial program. In another embodiment, the documents associated with a task can be determined based on user feedback. For instance, this may be done by recording documents actually viewed by users 40 when pursuing specific tasks in either a controlled setting such as a user study, or on the live site when a group of users 40 actually completes a task. Analysis of metrics can show which documents are typically viewed by a group of users before they purchase. Using the server example, it might be found by a particular company that there are seven critical documents that are viewed by 90% of customer groups before the group converts (such as the server home page, the product family page, one or more model pages, one or more specifications pages, a model comparison page, an options page, and the shopping cart page). In addition, other pages may be viewed before conversion by lesser percentages of those that convert (such as accessory pages, options detail pages, and configuration pages). By analyzing each task through the lens of previous customers who have completed the task, a marketer can determine which documents appear to be essential reading before the customer group is persuaded. In addition, other documents can be identified as related to the task, but not necessarily part of the core set. These documents could be important to certain segments of customers, but are not as intrinsic to persuasion as the core set.

In a further embodiment, the set of documents associated with a task can be refined over time. In this case, an initial set of documents is defined for a task, and the set is then refined over time based on actual group user behavior (for example, in a purchasing task, it may initially be thought that the warranty page is a core document, but later it may be determined that few visitors actually view the warranty page, so it can be removed from the core set of documents). One further embodiment of task definition system 24 includes “task discovery.” By analyzing document viewing patterns, analysis may reveal that common patterns might exist which are not associated with a known task. They may represent new tasks not currently known to the administrator. Alternatively, these patterns may represent additional patterns that can be associated with known tasks. In either case, task definition system 24 may discover tasks which can offer untapped potential for the Web site.

A task signature can also be defined for each task to offer a means to identify that a user from a group is engaged in a defined task. In one embodiment, the task signature is created automatically by the creation of the task's document set. In this case, the task signature identifies that a user from a group is engaged in a task based simply on whether the documents being viewed are within a particular task's document set.

One or more task triggers can also be defined for a task. Task triggers are events or situations that directly indicate that a user from a group is engaging in a particular task. Defining task triggers allows the administrator 36 to establish set triggers for each task to identify a task, as opposed to discerning the identity of a task by the task signature. Triggers can be any event, including clicking on a link or button on a web page, viewing a document, calling a telecenter, opening or sending an email, etc. A trigger can be as simple as declaring certain documents as being unique to a particular task (such as a compare models page for buying a server). In this case, anyone viewing that single page would automatically be assumed to be performing that task. Triggers are recorded along with the document set associated with each task.

One or more completion indicators can also be defined for a task. This includes, but is not limited to, a task-completion page (e.g., a confirmation page of a web commerce transaction), the selection of a specific link or control on the web page (e.g., a button to request more information), off-line events (e.g., the completion of a purchase through a telecenter), one of the users from a group indicating completion (e.g., the customer clicks a “this solved my problem” button on a technical support page), a download, etc. In some situations, the marketer may need to engage in research with customer test subjects to assess at which point they report that the task is complete. Whatever method, listed above or otherwise, is used to determine the completion indicators, this information is recorded along with the document set associated with each task.

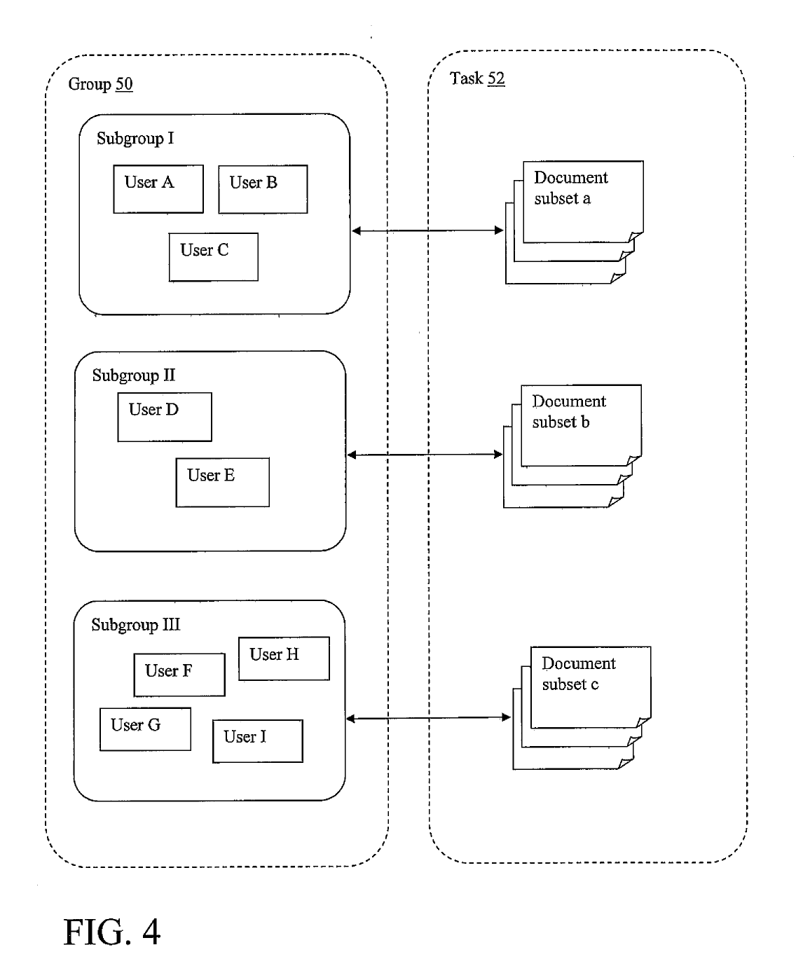

Group identification system 23 identifies a group that a user interacting with web portal 42 belongs to. As noted above, any now known or later developed process for identifying groups may be utilized. FIG. 4 depicts a further embodiment in which users are identified as belonging to subgroups (e.g., subgroup I, II or III) within the identified group 50. In this case, each subgroup has an associated document subset (e.g., document subset a, b or c). Thus for example, subgroup I may include all of the technical users visiting a web portal, subgroup II may include all of the management users visiting the portal, and subgroup III may include all of the marketing users visiting the portal. Each subgroup is associated with a portion of the overall task 52 as defined by a document subset.

Referring back to FIG. 1, task processing system 25 analyzes user activity as users within a group of users 40 engage with web portal system 42, and generally includes an activity tracking system 26, a task determination system 28 and a progress analysis system 30. Activity tracking system 26 tracks each group's activity when they visit web portal system 42 or otherwise engage with CRM system 46. This may be accomplished by keeping a record of each document viewed by a group, a count of how many times the document was viewed, a time stamp of when the document was last viewed, etc.

Moreover, activity tracking system 26 tracks all group-based activity, including activity from previous visits. Activity history database 34 may be utilized to store activity history for each user for each visit. Aging may be applied to remove old activity from the record after a sufficient period of time has elapsed. Activity tracking system 26 may utilize any mechanism for recognizing members of a group across multiple sessions, e.g., using cookies, a login process, an email address, etc.

FIG. 3 depicts an example in which group-based user activity has been recorded for the characterized documents shown in FIG. 2. In this example, it can be seen that users a, b and c from group 40 viewed “Descriptions and Features”, users c and d viewed “Specifications”, and user c viewed “Accessories”. Obviously, the manner in which user activity is stored and collected can be done in any now known or later developed technique, and FIG. 3 is depicted as one example.

Referring again to FIG. 1, task determination system 28 determines which tasks a user/group of users 40 are engaged in while visiting the web portal system 42. This may be done in any manner. If the user is determined to be a member of a group, then it may be known that the group is already engaged in a task. Further, if one or more members of a group have interacted with an item defined as a trigger (e.g., a start page, etc.), a task is considered to have been started. Sometimes a trigger may be sufficient to determine the task is underway, but under many circumstances, a trigger may not exist that uniquely identifies a task. In these cases, the group's activity must be compared against the “signature” of each task and a calculation of how closely the activity matches each signature is performed. The calculation may apply a certain threshold of documents viewed from the total number of core documents that comprise a task, select the task with the largest portion of its document set already viewed by the group, take into account viewing multiple documents in a certain order, etc. The closest match to a signature identifies the task, since in a group-driven series of document views, the group may be feeling their way towards some goal with a series of attempts to get on a successful path. For example, when a first user of a group views general information for a server model, and then a second user of the group views its specification pages, the group might be trying to purchase that computer, or might be trying to determine which wireless protocols are supported before buying a wireless network—only by observing further steps can a better determination be made. Task determination system 28 allows the administrator 36 to determine whether to identify both possible tasks as underway (with one fading away as more information becomes known) or to delay identification until one task or the other is clearly underway.

In addition, incrementally applying the most recent documents viewed within the comparison process can be used to distinguish multiple tasks within the same visit from each other. The administrator 36 may choose to record task initiation, progress and completion, or may recalculate tasks in progress whenever needed for reporting, analysis, and dynamic changes to the site during a visit.

Progress analysis system 30 tracks the progress of a group of users 40 towards completing a task. Over time, the creation of a canonical set of tasks that each tends to be completed after the viewing of certain core documents allows marketers to assess how many customer groups are in the pipeline and how far into their tasks they are. At a point in time, for example, marketers could identify that there are 30 customer groups in the midst of purchasing a server and that 30% of them have viewed three or fewer documents of the seven core documents, 55% had viewed between four and six of the core documents, and 15% had viewed all seven, but still had not completed the task.

Various metrics can be employed to assess the progress of a group in completing their tasks, including:
(1) The average number of documents viewed when the task became complete;
(2) The number of documents viewed by each group identified as performing a task;
(3) The number of times each document was viewed by members of a group who completed the task;
(4) The percentage of groups who historically complete tasks having viewed different combinations of documents; and
(5) The percentage of groups who complete the task within a certain number of sessions or within a certain period of time.

These metrics and others can be used to assess the revenue and profit value of the pipeline. Historical measures can be used to calculate the probability of groups completing each task based on the documents viewed and the number of sessions in which they viewed them and the period of time over which they viewed them. Applying these probabilities to the groups who have tasks in progress at any point in time, a projection can be made of the number of sales that will eventually be made. (Using the average revenue and profit historically associated with these sales can yield projected revenue and profit for groups in the pipeline.)

As noted above, adaptive marketing system 32 may be utilized to deliver dynamic marketing to a group of users 40 based on task progress. Understanding where a group is within a task, adaptive marketing system 32 can adapt the user experience, e.g., using dynamic content display techniques, to better persuade groups to complete their tasks. Once groups are identified as having commenced a particular task (as described above), it is known which documents (from the core set of documents from that task) they have already seen. Marketers can then employ business rules that drive a personalized experience to systematically expose groups to more of the core set of documents.

For example, if a group is identified to have begun the process of purchasing a server, and has viewed the specifications of two different systems, a user from the group might be prompted to compare the two models in a merchandising box on that specification page. If that user is comparing two models from the same product family, the user might be prompted to view the product family page (if he or she had not already done so).

For each group, the record of which pages (from the core set) they have seen is used by the business rules to prompt the one or more members of the group to view some or all of the remaining pages in that core set, based on the business rules. Over time, the conversion results of these prompted viewings of the core set of documents can be used to reevaluate which documents belong in the core set, and to determine when particular core documents have more persuasive power in different contexts. It is likely that patterns will emerge as to what the best document is to show next when a customer has seen a particular set of documents already.

Some groups will be presented (or voluntarily view) most or all of the core documents without converting. At this point, business rules may begin to present documents from the non-core documents associated with the task—those that a significant subset of purchasers have viewed before converting, but which were not found to distinguish task completers from those who do not finish the task. Eventually other related documents from the current subject or other subjects may be offered. For example, some purchasers may need to see the warranty before purchasing, but most tend not to need that information.

When members of a group have chosen documents that apply to multiple tasks, business rules could present the “next” core documents from more than one of these tasks, allowing the group member to select the document found to be most relevant. That selection then further informs as to which task the group member is performing. In some contexts, the user could be explicitly asked to choose between the tasks as part of the experience.

While the examples shown here have focused on the example of purchasing a server, task analysis system 18 can be applied to any task that can be identified. Customer service and support tasks, tasks for contacting a company offline, or anything else that can be completed on the web can use this method to identify the core information required to induce a group to complete the task.

In addition, while the examples shown here employ a website to present a personalized “next” document, any method that a system can use to present a document can be employed. E-mail re-contact strategies, personalized RSS feeds, initiating outbound calls, the course taken during a single telephone conversation, and other methods can be used to present the “next” piece of information to the customer—the information most likely to persuade completion of the task.

Referring again to FIG. 1, it is understood that computer system 10 may be implemented as any type of computing infrastructure. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, telephone, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising a task analysis system 18 could be created, maintained and/or deployed by a service provider that offers the functions described herein for customers. That is, a service provider could offer to deploy or provide the ability to analyze user behavior as described above.

It is understood that in addition to being implemented as a system and method, the features may be provided as a computer-readable medium storing a program product, which when executed, enables computer system 10 to provide a task analysis system 18. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions. In addition, each block of the block diagram may be implemented in whole, in part, or in various sub-combinations through the use of a provider or application service hosted externally to the core system operation.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A system for analyzing tasks being performed by a group in an online environment, comprising:
a task definition system for associating subsets of documents available via a content delivery system with a plurality of tasks;
a group identification system for identifying a group to which a user participating in the online environment belongs;
a tracking system for tracking which documents have been viewed by users within the group;
a task determination system for determining which of the plurality of tasks the group is engaged in performing; and
a progress analysis system for analyzing a progress the group has achieved towards completing the task.

2. The system of claim 1, wherein the content delivery system comprises a website.

3. The system of claim 1, further comprising an adaptive marketing system that dynamically presents content to users in the group based on an analysis of the progress the group has achieved towards completing the task.

4. The system of claim 1, further comprising a system for identifying subgroups with the group.

5. The system of claim 1, wherein the task definition system includes a system for defining a signature for each task.

6. The system of claim 1, wherein the task definition system includes a system for defining a task trigger for a task.

7. The system of claim 1, wherein the task definition system includes a system for defining a completion indicator for each task.

8. The system of claim 1, wherein the activity tracking system tracks a date, time and frequency of views of a document by the group.

9. The system of claim 1, wherein each document consists of an element selected from the group consisting of: a web page, a link, an advertisement, an email, an RSS feed, a graphic item, a multimedia item, a content item, and a text message.

10. A method of analyzing tasks being performed by a group in an online environment, comprising:
associating subsets of documents available via a content delivery system with a plurality of tasks;
identifying a group to which a user participating in the online environment belongs;
tracking which documents have been viewed by users within the group;
determining which of the plurality of tasks the group is engaged in performing; and
analyzing a progress the group has achieved towards completing the task.

11. The method of claim 10, wherein the identifying includes identifying subgroups within the group.

12. The method of claim 10, further comprising dynamically presenting content to users within the group based on an analysis of the progress the group has achieved towards completing the task.

13. The method of claim 12, further comprising utilizing information collected about the group to refine content presented to the group.

14. The method of claim 10, further comprising:
defining a signature for each task;
defining a task trigger for each task; and
defining a completion indicator for each task.

15. The method of claim 10, wherein the tracking tracks a date, time and frequency that a document was viewed by the group.

16. The method of claim 10, wherein each document consists of an element selected from the group consisting of: a web page, a link, an advertisement, an email, an RSS feed, a graphic item, a multimedia item, a content item of any type (including but not limited to a graphic or multimedia item), and a text message.

17. A computer readable medium having a computer program product stored thereon for analyzing a task in an online environment, comprising:
program code for associating subsets of documents available via a content delivery system with a plurality of tasks;
program code for identifying a group to which a user participating in the online environment belongs;
program code for tracking which documents have been viewed by users within the group;
program code for determining which of the plurality of tasks the group is engaged in performing; and
program code for analyzing a progress the group has achieved towards completing the task.

18. The computer readable medium of claim 17, wherein the program code for identifying a group identifies subgroups.

19. The computer readable medium of claim 17, further comprising program code for dynamically presenting content to the group based on an analysis of the progress the group has achieved towards completing the task.

20. The computer readable medium of claim 17, further comprising
program code for defining a signature for each task;
program code for defining a task trigger for each task; and
program code for defining a completion indicator for each task.

21. The computer readable medium of claim 17, wherein the program code for tracking tracks a date, time and frequency that a document was viewed by the group.

22. A method for deploying a system for measuring completeness of a task, comprising:
providing a computer infrastructure being operable to:
associate subsets of documents available via a content delivery system with a plurality of tasks;
identify a group to which a user participating in the online environment belongs;
track which documents have been viewed by users within the group;
determine which of the plurality of tasks the group is engaged in performing; and
analyze a progress the group has achieved towards completing the task.
